(19) United States
(12) Patent Application Publication
(10) Pub. No.: US 2017/0109695 A1
(43) Pub. Date: Apr. 20, 2017

(54) METHOD AND SYSTEM FOR SHIPPING WORKFLOW USING NATURAL LANGUAGE PROCESSING

(71) Applicant: Pitney Bowes Inc., Danbury, CT (US)

(72) Inventor: Mitun BALUSAMY, Danbury, CT (US)

(73) Assignee: Pitney Bowes Inc., Danbury, CT (US)

(21) Appl. No.: 15/046,838

(22) Filed: Feb. 18, 2016

Related U.S. Application Data
(60) Provisional application No. 62/241,832, filed on Oct. 15, 2015.

(51) Int. Cl. G06Q 10/08

(52) U.S. Cl. CPC G06Q 10/08345

(57) ABSTRACT

Methods and systems for performing, a shipping workflow using natural language processing are provided. A shipper provides a natural language command to ship an item, either in voice or text format. If in voice format, the system converts the speech to text. From the text command, the system identifies product attributes for the product that will be shipped, the recipient of the product, the origin and destination location, and the timeliness with which the shipper desires it to be delivered. The system uses the product attributes, the origin and destination locations, and timeliness with which the shipper desires the product to be delivered to search for one or more carriers that provide services to ship the package, and then display to the shipper for selection the one or more carriers that meet the shippers requirements for shipping the product.

### CROSS REFERENCE TO RELATED APPLICATIONS

This application claims the benefit of U.S. Provisional Application Ser. No. 52/241,832, filed Oct. 15, 2015, the specification of which is hereby incorporated by reference.

### FIELD OF THE INVENTION

The invention disclosed herein relates generally to shipping systems, and more particularly to methods and systems for performing a shipping workflow using natural language processing.

### BACKGROUND OF THE INVENTION

The process of shipping workflow conventionally requires a shipper to enter certain information about the item to be shipped, including, for example, recipient address, item attributes, e.g., weight, dimensions, etc., into the shipping system operating on the user's computing device. This is typically performed either by the'user manually entering the information into the user's computing device via an input device such as a keyboard, mouse, or touchscreen, or by automatic entry such as a scale connected to the users computing device. This can take a significant amount of time, as well as in errors in the input information. As retailers offer more and more pr educts that can be Ordered on-line and shipped anywhere in the world, the ability to easily ship products in a time efficient manner is required.

### SUMMARY OF THE INVENTION

The present invention alleviates the shortcomings described above by providing methods and systems for more efficiently performing a shipping workflow using natural language processing.

According to the present invention, a shipper provides a natural language command to the system to ship an item, either in voice or text format. If in voice format, the system converts the speech to text. The text is then processed to identify the command as a request to ship an item. Based on the identified command, the system initiates a shipping workflow process. From the text command, the system identifies the product that will be shipped, the recipient of the product, the origin and destination location, and the timeliness with which the shipper desires it to be delivered. Based on the identified product, the system queries a database for an estimation of product attributes, e.g., weight, dimensions, product classification (HS Code), restrictions, etc., based on either the actual product or a best match for the product. The system uses the product attributes, the origin and destination locations, and timeliness with which the shipper desires the product to be delivered to search for one or more carriers that provide services to ship the package. The system will then display to the shipper one or more carriers that meet the shipper's requirements, and the shipper can select a carrier for shipping the product.

### DESCRIPTION OF THE DRAWINGS

The accompanying drawings illustrate presently preferred embodiments of the invention, and together with the general description given above and the detailed description given below, serve to explain the principles of the invention. As shown throughout the drawings, like reference numerals designate like of corresponding parts.

FIG. 1 illustrates in block diagram form a shipping system according to an embodiment of the present invention;

FIG. 2 illustrates in block diagram form modules of the shipping application server of FIG. 1 according to an embodiment of the present invention;

FIG. 3 illustrates in flow diagram form the processing performed by the natural language processing engine of FIG. 2 according to an embodiment of the present invention; and

FIGS. 4A and 4B illustrate in flow chart form the overall processing performed by the shipping system according to an embodiment of the present invention.

### DETAILED DESCRIPTION OF THE PRESENT INVENTION

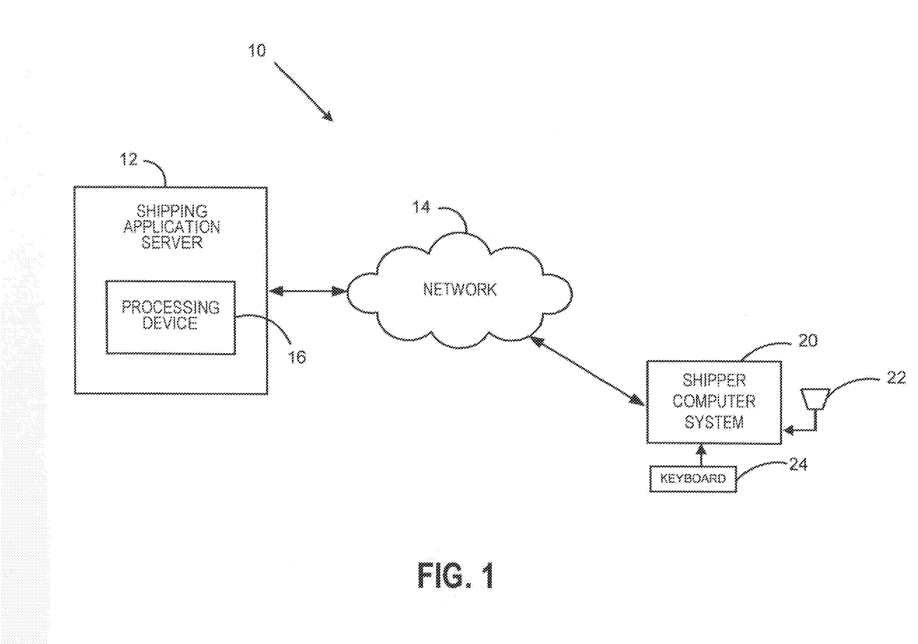

In describing the present invention, reference is made to the drawings, wherein there is seen in FIG. 1 a block diagram of a shipping system 10. System 10 in a shipping application server 12 that is coupled to a communication network 14, such as, for example, the Internet or any other type of communication network. Server 12 may be a mainframe or the like that is specially constructed for the required purposes, or it may comprise a general purpose computer selectively activated or reconfigured by a computer program (described further below) stored therein. Such a computer program may alternatively be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, which are executable by a processing device 16 within the server 12. One of ordinary skill in the art would be familiar with the general components of a server system upon which the method of the present invention may be performed.

System 10 also includes a shipper computer system 20 operated by or on behalf of a shipper of goods. Computer system 20, may be, for example, a personal computer or the like, which can include, for example, smart-phones, tablets, personal data assistants, or any other type of electronic device that has network capability and can allow a user to access the network 14 to send data to and receive data from the shipping application server 12. It should be understood that the number of shipper computer systems 20 are not limited in number, and any number can be connected to the network 14. Each shipper computer system 20 is equipped with various input devices, which can include for example, a microphone 22 and a keyboard 24 that enables the computer system 20 to capture entries made by a human. One or more applications or application programming interfaces (APIs) are executed by the shipper computer system 20 that allow the shipper computer system 20 to interact with the shipping application server 12. Each shipper registers with the shipping application server 12 to establish an account for shipping. Each account maintains necessary information about the shipper, such as the shippers name, the address from which items will be shipped (origin location), billing information, preferences as to carriers/services desired to be used by the shipper, and the like.

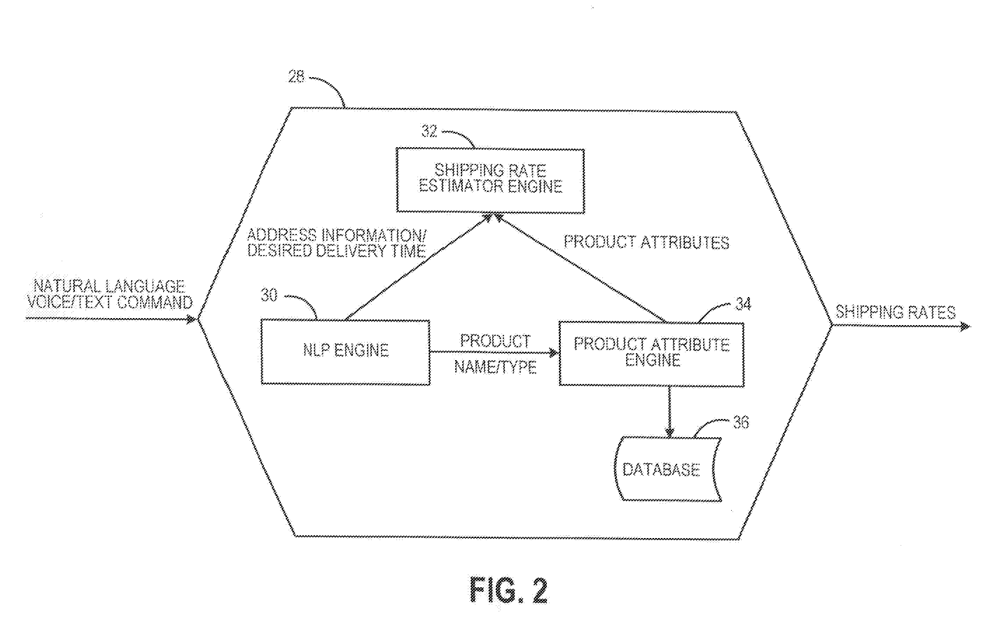

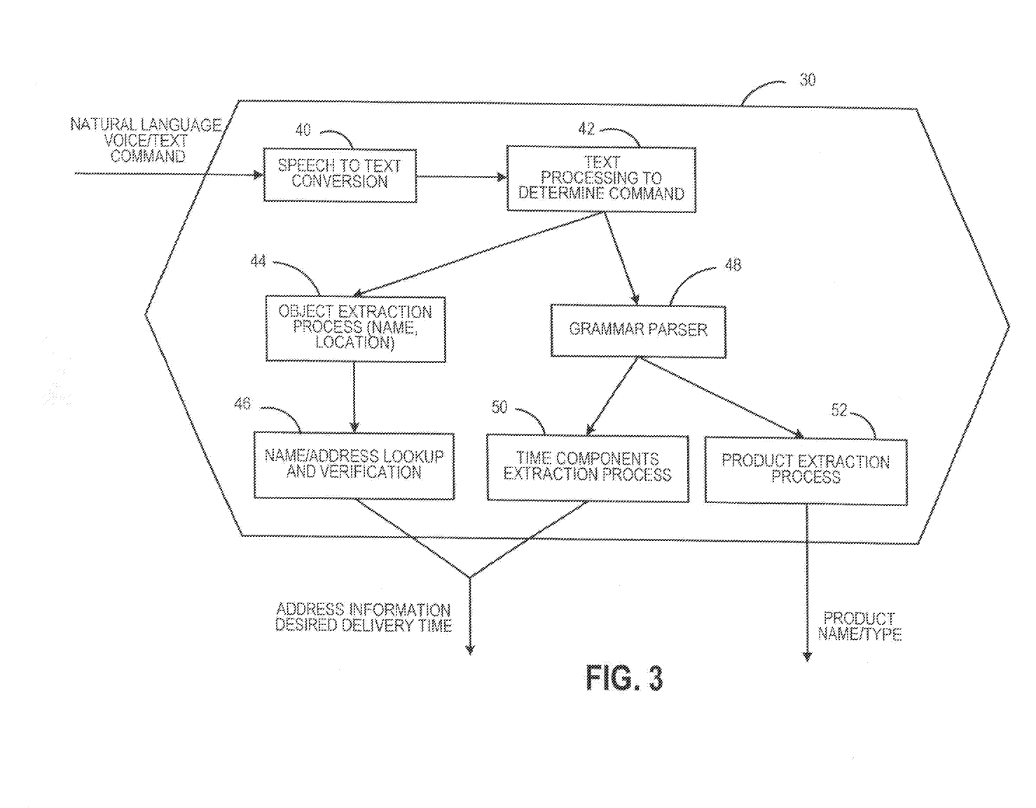

FIG. 2 illustrates in block diagram form the modules of a shipping application 28 running on the shipping application server 12 of FIG. 1 according to an embodiment of the present invention. Each of the modules may be implemented in software, hardware or a combination of the two. The modules include a natural language processing (NLP) engine 30, a shipping rate estimator engine 32, and a product attribute engine 34. The product attribute engine is coupled to a database 36 that is used to store attributes about different products, which can include, for example, a product's dimensions, weight, classification according to the Harmonized System (HS) code, etc. The NLP engine 30 receives a natural voice or text request from the shipper computer system 20, and processes the request as described below with respect to FIG. 3 to extract address information, a desired delivery timeframe requirement (if provided) and a product name/type from the request. The address information and desired delivery timeframe are sent to the shipping rate estimator engine 32. The product name/type is sent to the product attribute engine 34. The product attribute engine 34 receives the product name/type and processes it to determine a best match for a specific product based on the name/type. It then queries the database 36 to obtain one or more attributes the best matched product, and provides those attributes to the shipping rate estimator engine 32. The shipping rate estimator engine 32, using the address information received from the NLP engine 30 and product attribute engine 34, obtains shipping rates from one or more carriers that are stored in relational databases accessed by the shipping rate estimator engine for shipping the product. If a desired delivery timeframe was provided, the shipping rate estimator 34 uses the desired delivery timeframe to filter the received rates to include only those services that will meet the desired delivery timeframe. A list of one or more carriers and services that will meet the desired delivery timeframe, along with the shipping rates, are returned to the shipper computer system 20 for display to the shipper, and the shipper can select the desired carrier and service for shipping the product to the destination.

FIG. 3 illustrates in flow diagram form the processing performed by the NLP engine 30 of FIG. 2 according to an embodiment of the present invention. When the shipping application server 12 receives a natural language voice/text request from the shipper computer system 12, in step 40 if the request is a speech request it is converted to text, using any known speech to text conversion. Once converted, or if already in text format, then in step 42 the text is processed to determine if it is a request to initiate a shipping workflow, i.e., it the request is to ship an item to a recipient. For example, the request could be “I want to send an iPhone to John Smith in Danbury, Conn.,” This text is analyzed using a predictive models to determine what is bins requested using the actual words of the text, the positions of the words in the sentence, etc. If it has been determined that the request is a request to initiate a shipping workflow, then the text, is subjected to an object extraction process in step 44 and a grammar parser in step 48. The object extraction process is responsible for determining the recipient's name and address, and the origin location. The origin location is determined from the information provided by the shipper when the shipper registered with the shipping application server 12. The recipient name and address is determined based on the information included in the text in conjunction with one or more address books/records for the shipper. For example, the shipper may maintain an address book with the shipping application server 12 that can be searched in step 46 to obtain matching information. Optionally, an address book maintained on the shipper computer system 20 could also be searched using an API call from the shipping application server 12 to obtain matching information. From the example above, the object extraction process can search the shippers address book for a John Smith located in Danbury, Conn., if no records are found, a record is incomplete, or more than one match is found the shipping application server 12 will sent a request to the shipper computer system 20 for the shipper to input additional information as necessary to determine exactly where the shipper desires to send the product. Once a single match has been determined, a request can be sent to the shipper computer system 20 for the shipper to verify the name and address of the recipient.

In step 48 a grammar parser parses the text to identify the parts of speech of each word in the text, e.g., noun, verb, adjective, direct object, indirect object, etc., and each word is tagged with a grammatical label. In step 50, the tagged text is subjected to a time component extraction process to determine which word in the text has the highest probability of being a desired delivery timeframe (e.g., one day, three days, etc.) based at least in part on the words themselves, the grammatical tag attached to each of the words, and the position of the words in the sentence. In some cases, there may not be a desired delivery timeframe. Similarly, in step 52, the tagged text is subjected to a product extraction process to determine which word in the text has the highest probability of being the product's name/type based at least in part on the words themselves, the grammatical tags attached to each of the words, and the position of the words in the sentence. As noted above, once the NLP engine 30 has determined the recipient address information, desired delivery timeframe (if provided) and product name/type, the address information and desired delivery time (if provided) is sent to the shipping rate estimator engine 32, and the product name/type is sent to the product attribute engine 34 for processing as described above with respect to FIG. 2.

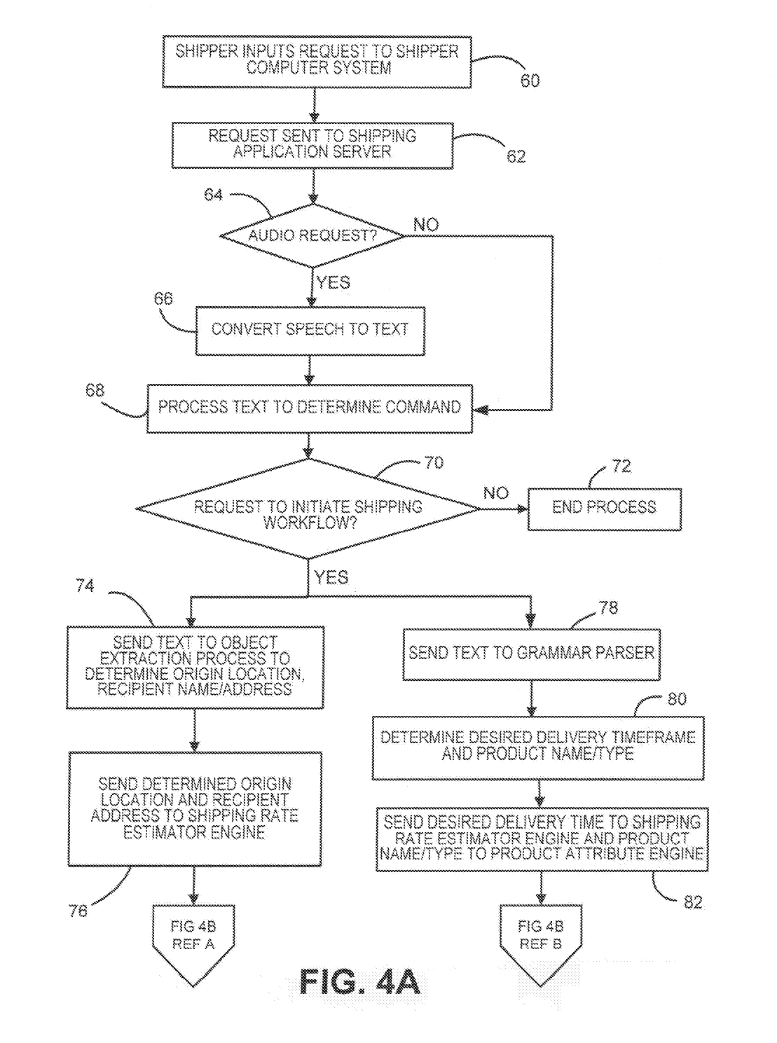

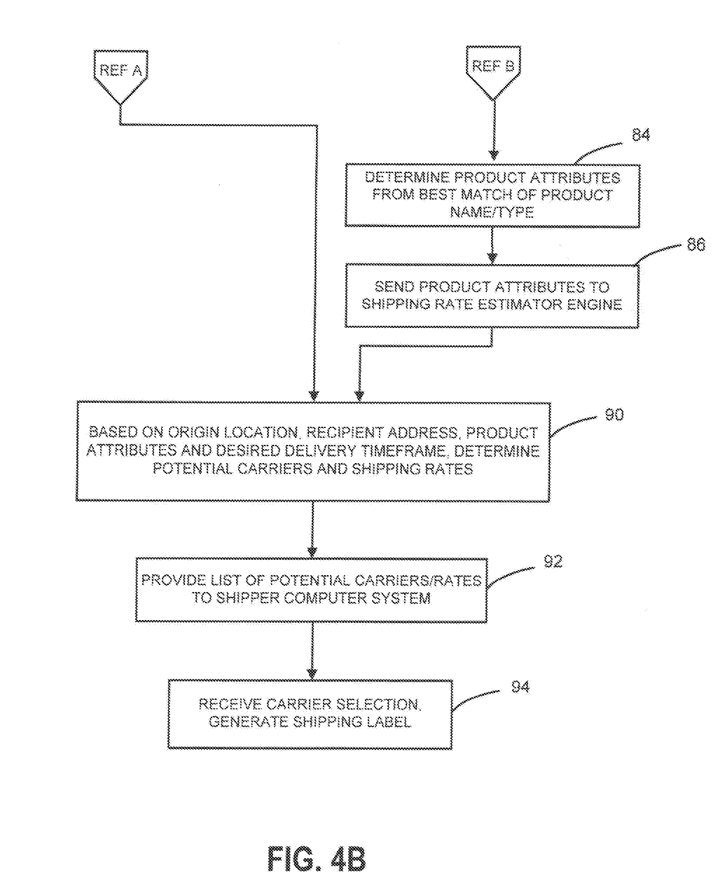

FIGS. 4A and 4B illustrate in flow chart form the overall processing performed by the shipping system 10 according to an embodiment of the present invention. The processing begins in step 60 when a shipper that desires to ship an item provides an input request to the shipper computer system 20 in natural language. Such input can be provided in the form, of spoken voice using the microphone 22, by typing in the request using the keyboard 24, or any other input device that allows for a natural language input. As an example, the shipper could either say or type “I want to send an iPhone to John Smith in Danbury, Conn.” In step 62, the input request is sent from the shipper computer system 20 to the shipping application server 12, via the network 14, for processing. In step 64, the processing device 16 of the shipping application server 12 determines if the input is in audio format (speech) or text format. If the input is in audio format, then in step 66 the audio request is converted to text using any type of speech-to-text conversion process (see FIG. 3, step 40). Once the audio request has been converted to text, or if it has been determined in step 64 that the input request was already in text format, then in step 68 the text is processed to determine the type of command included in the request (see FIG. 3, step 42). In step 70, it is determined if the request was a command to initiate a shipping application workflow to ship an item. If the command is not for shipping an item, then in step 72 the process ends, as the command is directed to something other than shipping an item. If it is determined in step 70 that the request is a command to initiate the shipping workflow, then in step 74 the text is sent to an object extraction process to determine the origin location, and the recipient name and address (see FIG. 3, steps 44, 46). In step 76, the origin location, and the determined recipient name and address, are sent to the shipping rate estimator engine 32 (FIG. 2).

Returning again to step 70, once it has been determined that the request is a command to initiate the shipping workflow, then in step 78 the text is also sent to a grammar parser to parse the text (see FIG. 3, step 48). It should be noted that steps 74 and 78 can be performed in parallel as illustrated, or in series if so desired. In step 80, the desired delivery time (see FIG. 3, step 50) and product name/type (see FIG. 3, step 52) are determined, and in step 82 the desired delivery time is sent to the shipping rate estimator engine 32 and the product name/type are sent to the product attribute engine 34. In step 84, attributes of the item necessary for determining a shipping rate for the tem, e.g., dimensions, weight, etc., are determined by the product attribute engine 34 as previously described. In step 86 the product attributes are sent to the shipping rate estimator engine 32.

In step 90, the shipping rate estimator engine 32 will determine one or more potential carriers, service levels, and the shipping rates for those service levels to ship the item from the shipper to the recipient based on the origin location recipient address, product attributes and desired delivery time. In step 92, a list of one or more carriers and services that will meet the desired delivery time, along with the shipping rates, are returned to the shipper computer system 20 for display to the shipper, and the can select the desired carrier and service for shipping the item to the destination the shipper computer system 20. In step 94, when the shipping application server 12 receives the carrier selection from the shipper, the shipping application server 12 can generate a shipping label for printing by a printing device associated with the computer system 12.

While preferred embodiments of the invention have been described and illustrated above, it should be understood that these are exemplary of the invention and are not to be considered as limiting. Additions, deletions, substitutions, and other modifications can be made without departing from the spirit or scope of the present invention. Accordingly, the invention is not to be considered as limited by the foregoing description but is only limited by the scope of the appended claims.

What is claimed is:

1. A method for a processing device to determine a shipping rate to ship an item from a shipper to a recipient, the method comprising:
receiving, by a shipping application server from a remote computer, a natural language request in voice or text form to ship the item to the recipient;
if the natural language request is in voice form, converting the natural language request to text form;
processing, by a natural language processing engine running on the shipping application server, the text form of the natural language request to determine at least one of a name and type of the item, and an address of the recipient using an address book associated with the shipper;
providing the at least one of the name and type of the item to a product engine running on the shipping application server;
obtaining, the product attribute engine, one or more physical attributes of the item from a database based on the at least one of the name and type of the item;
providing the determined address of the recipient and the one or more physical attributes of the item to a shipping rate estimator engine running on the shipping application server;
obtaining, by the shipping rate estimator, a shipping rate to ship the item from the shipper to the recipient for at least one carrier based on the determined address of the recipient and the one or more physical attributes of the item; and
providing the shipping rate to ship the item from the shipper to the recipient for the at least one carrier to the remote computer.

2. The method of claim 1, further comprising:
processing, by the natural language processing engine running on the shipping application seer, the text form of the natural language request to determine a desired delivery timeframe for delivery of the item; and
providing the desired delivery timeframe to the shipping rate estimator engine running,
wherein the shipping rate estimator engine obtains a shipping rate based on the determined address of the recipient, one or more physical attributes of the item, and the desired delivery timeframe.

3. The method of claim 1, wherein the address book associated with the shipper is stored by the shipping application server.

4. The method of claim 1, wherein the address book associated with the shipper is stored by the remote computer.

5. The method of claim 1, wherein the one or more physical attributes of the item includes at least one of a weight of the item and dimensions of the item.

6. The method of claim 1, wherein the address of the recipient is determined using an object extraction process.

7. The method of claim 1, wherein the at least one of the name and type of the item is determined using a grammar parser.

8. The method of claim 1, wherein obtaining a shipping rate by the shipping rate estimator further comprises:
obtaining a shipping rate for a plurality of carriers for shipping the item from the shipper to the recipient.

9. A system for determining a shipping fate for shipping an item from a shipper to a recipient, the system comprising:
a shipping application coupled to a network, the shipping application server receiving from a remote computer via the network a natural language request in voice or text form to ship the item to the recipient, and, if the natural language request is in voice form, converting the natural language request to text form;
a natural language processing engine running on the shipping application server, the natural language processing engine processing the text form of the natural language request to determine at least one of a name and type of the item, and an address of the recipient using an address book associated with the shipper;
a product attribute engine running on the shipping application server, the natural language processing engine providing the at least one of the name and type of the item to the product attribute engine, the product attribute engine obtaining one or more physical attributes of the item from a database based on the at least one of the name and type of the item; and
a shipping rate estimator engine running on the shipping application server, the shipping rate estimator receiving the determined address of the recipient and the one or more physical attributes of the item and obtaining a shipping rate to ship the item from the shipper to the recipient for at least one carrier based on the determined address of the recipient and the one or more physical attributes of the item;
wherein the shipping application server provides the shipping rate to ship the from the shipper to the recipient for the at least one carrier to the remote computer.

10. The system of claim 9, wherein the natural language processing engine further processes the text form of the natural language request to determine a desired delivery timeframe for delivery of the item and provides the desired delivery timeframe to the shipping rate estimator engine running,
wherein the shipping rate estimator engine obtains a shipping rate based on the determined address of the recipient, one or more physical attributes of the item, and the desired delivery timeframe.

11. The system of claim 9, wherein the address book associated with the shipper is stored by the shipping application server.

12. The system of claim 9, wherein the address book associated with the shipper is stored by the remote computer.

13. The system of claim 9, wherein the one or more physical attributes of the item includes at least one of a weight of the item and dimensions of the item.

14. The system of claim 9, wherein the address of the recipient is determined using an object extraction process.

15. The system of claim 9, wherein the at least one of the name and type of the item is determined using a grammar parser.

16. The system of claim 9, wherein the shipping rate estimator obtains a shipping rate for a plurality of carriers for shipping the item from the shipper to the recipient.
